(19) United States
(12) Patent Application Publication
(10) Pub. No.: US 2026/0124023 A1
(43) Pub. Date: May 7, 2026

(54) ADDITIVELY MANUFACTURED ORTHODONTIC APPLIANCES

(71) Applicant: LightForce Orthodontics, Inc., Wilmington, MA (US)

(72) Inventors: Oisín Duggan, Somerville, MA (US); Peter Polesnak, Wilmington, MA (US); Daniel Cheng, Wilmington, MA (US); Thomas Muscolo, Cambridge, MA (US); Dylan Winchell, Belmont, MA (US); Martin Jay, Wilmington, MA (US); Michael Andrecyk, Boston, MA (US); Richard Liebert, Brookline, MA (US)

(73) Assignee: LightForce Orthodontics, Inc., Wilmington, MA (US)

(21) Appl. No.: 19/379,474

(22) Filed: Nov. 4, 2025

Related U.S. Application Data
(60) Provisional application No. 63/716,623, filed on Nov. 5, 2024.

(51) Int. Cl. A61C 7/16; A61C 13/34; B33Y 40/20; B33Y 50/00; B33Y 80/00; G06F 30/12

(52) U.S. Cl. CPC A61C 7/16; A61C 13/34; B33Y 40/20; B33Y 50/00; B33Y 80/00; G06F 30/12

(57) ABSTRACT

The techniques described herein relate to additively manufactured orthodontic appliances. An example custom metal orthodontic bracket includes a body, a plurality of tie-wings, and a base. The base includes a base surface that is contoured to a shape of a tooth of a patient to which the custom metal orthodontic bracket is to be bonded, and a plurality of retentive structures, wherein at least one of a portion of the base is not polished or only partially polished, or a portion of at least one of the plurality of retentive structures is not polished or only partially polished. An example method for manufacturing a custom orthodontic bracket includes measuring dentition data of a patient, constructing a three-dimensional (3D) model of at least one tooth of the patient, designing a 3D model of the bracket, preparing feedstock, building the bracket, removing the feedstock, hardening the bracket, and polishing the bracket.

### RELATED APPLICATIONS

This application claims priority under 35 U.S.C. §119(e) to U.S. Provisional Application No. 63/716,623, filed Nov. 5, 2024, the content of which is incorporated by reference in its entirety for all purposes.

### FIELD

The techniques described herein relate generally to orthodontic appliances and, more particularly, to additively manufactured orthodontic appliances.

### BACKGROUND

Orthodontic procedures involve orthodontic appliances such as braces, which apply static mechanical forces to the teeth to induce bone remodeling and facilitate alignment. Orthodontic treatment planning may utilize 3D models of a patient's teeth to create a treatment plan for the patient, which may, for instance, include determining where to place brackets for a set of braces.

### SUMMARY

In accordance with the disclosed subject matter, additively manufactured orthodontic appliances are provided.

Some embodiments relate to a custom metal orthodontic bracket comprising a body, a plurality of tie-wings, and a base. The base comprises a base surface that is contoured to a shape of a tooth of a patient to which the custom metal orthodontic bracket is to be bonded and a plurality of retentive structures. For at least one of the retentive structures of the plurality of retentive structures, a portion of the base is not polished or only partially polished, or a portion of at least one of the plurality of retentive structures is not polished or only partially polished.

Some embodiments relate to a custom metal orthodontic tube comprising a base, a first tube comprising a first slot surrounded by a first plurality of walls for receiving a wire, and a second tube comprising a second slot surrounded by a second plurality of walls for receiving the wire.

Some embodiments relate to a custom metal orthodontic bracket comprising a base comprising a base surface that follows a shape of a portion of tooth of a patient to which the customized metal orthodontic bracket is to be bonded; a face opposite the base, comprising a face surface that follows the shape of the tooth; and comprising a bottom surface and two side surfaces that provide an opening for receiving an archwire in an insertion direction, the insertion direction is angled with respect to the face surface and the base surface.

Some embodiments relate to a method for additively manufacturing a custom orthodontic bracket, the method comprising measuring dentition data of a patient; constructing, using the dentition data, a three-dimensional (3D) model of at least one tooth of the patient; designing, using the 3D model of the at least one tooth of the patient, a 3D model of the bracket; preparing feedstock; building, using an additive manufacturing device and the feedstock, the bracket; removing the feedstock; hardening the bracket; and polishing the bracket. In some embodiments, the 3D model of the bracket comprises a body, a plurality of tie-wings, and a base. In some embodiments, a base surface that is contoured to a shape of a tooth of a patient to which the bracket is to be bonded and a plurality of retentive structures. In some embodiments, designing the 3D model of the bracket comprises at least one of configuring the base and/or tie-wings to have custom text; configuring a height and width of the base, the plurality of tie-wings, and/or the base; configuring a shape of an edge of the base; configuring a size and/or a spacing of the plurality of retentive structures; configuring an alignment of the plurality of tie-wings and/or the base with respect to a central axis of each respective component; configuring angular positioning of the plurality of tie-wings; or configuring a position of the body relative to the base.

The foregoing summary is not intended to be limiting. Moreover, various aspects of the present disclosure may be implemented alone or in combination with other aspects.

### BRIEF DESCRIPTION OF THE DRAWINGS

FIG. 1 illustrates an example of an orthodontic treatment platform environment for generating orthodontic treatment plans, in accordance with some embodiments of the technology described herein.

FIG. 2 is a flowchart of an example custom, additive manufacturing process to manufacture metal orthodontic components, in accordance with some embodiments of the technology described herein.

FIG. 3A shows a rear perspective of a customized metal orthodontic bracket with retentive structures, in accordance with some embodiments of the technology described herein.

FIG. 3B shows a cross-sectional side view of the customized metal orthodontic bracket of FIG. 3A, in accordance with some embodiments of the technology described herein.

FIGS. 4A-4D show customized metal orthodontic brackets, in accordance with some embodiments of the technology described herein.

FIG. 5A shows a customized metal orthodontic tube with a first and second tube, in accordance with some embodiments of the technology described herein.

FIG. 5B shows a customized metal orthodontic tube with one tube, in accordance with some embodiments of the technology described herein.

FIG. 6 shows a direct part marking of a customized metal orthodontic bracket and tube, in accordance with some embodiments of the technology described herein.

FIG. 7 shows an example implementation of an example computing system that may be configured to effectuate custom, additive manufacturing processes, in accordance with some embodiments of the technology described herein.

FIG. 8 shows an example orthodontic bracket with a bracket surface including intersecting bars, in accordance with some embodiments of the technology described herein.

FIG. 9 shows a front-view of a customized, dynamic metal orthodontic bracket with custom text, in accordance with some embodiments of the technology described herein.

FIG. 10 shows a front-view of the customized, dynamic metal orthodontic bracket of FIG. 9 with custom heights and widths, in accordance with some embodiments of the technology described herein.

FIG. 11 shows a perspective view of the customized, dynamic metal orthodontic bracket of FIG. 9 with custom base curvature, in accordance with some embodiments of the technology described herein.

FIG. 12 shows a rear view of the customized, dynamic metal orthodontic bracket of FIG. 9 with custom retentive feature architecture, in accordance with some embodiments of the technology described herein.

FIG. 13 shows a front view of the customized, dynamic metal orthodontic bracket of FIG. 9 with custom component alignment with respect to a central axis of the respective components, in accordance with some embodiments of the technology described herein.

FIG. 14 shows a side view of the customized, dynamic metal orthodontic bracket of FIG. 9 with custom component angular positioning, in accordance with some embodiments of the technology described herein.

FIG. 15 shows a side-view of a customized, dynamic metal orthodontic tube with custom hook angular positioning, in accordance with some embodiments of the technology described herein.

### DETAILED DESCRIPTION

Orthodontics have been widely adopted in clinics to correct malocclusion and straighten teeth. The traditional method is to adhere preformed brackets onto the teeth and run elastic metal wires of round, square, or rectangular cross-sectional shape through the bracket slots to provide the driving force. The adaptation of the bracket to the individual tooth is performed by filling the gap between the tooth surface and bracket surface with adhesive. This thereby bonds the bracket to the tooth such that the bracket slot, when the teeth are moved to their final position, lies in a predetermined location.

One type of orthodontic appliance includes ceramic appliances. Examples of ceramic appliances include ceramic brackets and tubes. The inventors have recognized that ceramic can be a desirable material due to its aesthetics, resistance to creep, rigidity, biocompatibility, corrosion resistance, stability in the oral environment, and/or non-toxic nature. Ceramic brackets can be manufactured by injection molding and/or 3D printing, and can be custom-designed through patient-specific treatment planning software as disclosed herein.

Another type of orthodontic appliance includes metal appliances. Examples of metal appliances include metal brackets and tubes. Metal brackets are typically off-the-shelf products that are not customized for a patient. Some custom metal lingual brackets are available that are fabricated at a central location from 3D scans or impressions of the dentition and mailed back to the clinician and transferred to the patient via indirect bonding. Selective laser melting (SLM) is a 3DAM technique that has been used to create custom metal lingual brackets, but this technique suffers from insufficient resolution and surface finish. Many conventional true custom labial systems rely heavily on putting custom bends in the wire based on a 3D scan rather than creating a true straight-wire appliance. For example, some such systems may weld a metal bracket slot to a stock metal bracket base into a custom position. Such systems do not create a custom bracket base or create an aesthetic, non-metal bracket. These partially custom metal brackets suffer from inaccuracy in slot position and premature debonding due to a stock bracket base that does not match the tooth morphology. Additionally, such partially custom metal brackets are unappealing to some patients who prefer to have non-metal brackets for aesthetic concerns.

The inventors have recognized and appreciated that a need exists for more efficient, accurate, and aesthetically pleasing techniques for manufacturing patient-specific (lingual and labial) metal orthodontic components. The techniques provide for creating custom metal orthodontic components, via additive manufacturing techniques, which allows for flexible orthodontic component designs and geometry, as well as in office planning and designing of such orthodontic components. The techniques are not so limited to creating custom metal orthodontic components. For example, techniques disclosed herein can also provide for creating custom ceramic orthodontic components.

In particular, the additive manufacturing process can build custom metal brackets layer-by-layer to generate an (initial) brick of material. The additive manufacturing process can wipe (or scrape) a small layer of material over the build plate, project a pattern onto the layer, wipe another layer over the build plate, project again, and so on, until the full brick of material is complete. This can allow for printing metal orthodontic components of almost any geometry due to how the brick supports the printed components during the printing process. Then, after the layer-by-layer printing process, the feedstock can be removed, and the brackets can be hardened and polished for orthodontic use.

Accordingly, some embodiments provide for a custom metal orthodontic bracket comprising a base comprising a base surface that is contoured to a shape of a tooth of a patient to which the customized metal orthodontic bracket is to be bonded, and a plurality of retentive structures, wherein a portion of the base and/or a portion of at least one of the plurality of retentive structures is not polished and/or is only partially polished.

Some embodiments provide for a custom metal orthodontic bracket comprising a slot configured to accept an archwire, and a series of additively manufactured layers that define a width of the slot.

Some embodiments provide for a custom metal orthodontic bracket comprising a slot configured to accept an archwire, a first 3D printed layer that defines a first side of the slot, a second 3D printed layer that defines a second side of the slot, and a set of middle layers between the first and second 3D printed layers that define the base of the slot.

Some embodiments provide for a custom metal orthodontic bracket comprising a series of 3D printed layers, and a slot configured to accept an archwire, wherein the 3D printed layers are manufactured layer-by-layer in a direction of a width of the slot, such that the custom metal orthodontic bracket is printed sideways. In some embodiments, the custom metal orthodontic bracket is printed in a direction not parallel to the direction of the width of the slot. As an example, the custom metal orthodontic bracket may be printed at an angle 45 degrees offset the direction of the width of the slot.

Some embodiments provide for a custom metal orthodontic bracket comprising a base comprising a base surface that follows a shape of a portion of tooth of a patient to which the customized metal orthodontic bracket is to be bonded, a face opposite the base, comprising a face surface that follows the shape of the tooth, a slot, comprising a bottom surface and two side surfaces that provide an opening for receiving an archwire in an insertion direction, and wherein the insertion direction is angled with respect to the face surface and the base surface.

Some embodiments provide for a custom metal orthodontic tube comprising a first tube comprising a first slot surrounded by a first plurality of walls for receiving a wire, and a second tube comprising a second slot surrounded by a second plurality of walls for receiving the wire.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

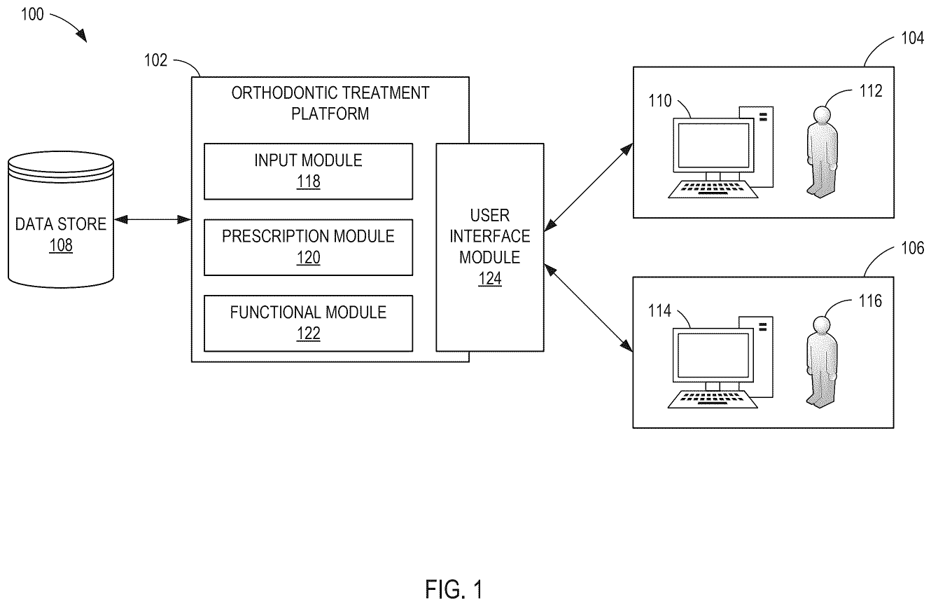

FIG. 1 illustrates an example of an orthodontic treatment platform environment 100 for generating orthodontic treatment plans. As shown, the orthodontic treatment platform environment 100 includes an orthodontic treatment platform 102, a first user environment 104, a second user environment 106, and data store 108. The first user environment 104 includes a first user device 110 operated by a first user 112. The second user environment 106 includes a second user device 114 operated by a second user 116. The orthodontic treatment platform 102 includes an input module 118, a prescription module 120, a functional module 122, and a user interface module 124.

The orthodontic treatment platform 102 may send information to and/or receive information from a data store 108 via the input module 118. Orthodontic prescriptions and/or treatment plans may be stored in data store 108. When modifying an orthodontic prescription and/or treatment plan, the orthodontic treatment platform 102 may access the data from the data store 108 for use by the other modules of the orthodontic treatment platform 102. In some embodiments, the input module 118 receives a three-dimensional (3D) dentition data of a patient.

The input module 118 may send information relating to the patient and/or dentition data of a patient for use by the prescription module 120.

The orthodontic treatment platform 102 facilitates orthodontic treatment planning between orthodontic practitioners. The prescription module 120 facilitates the generation, modification, and implementation of orthodontic prescriptions. In some embodiments, an orthodontic prescription describes the intended positions for a patient's teeth at the end of treatment. Accordingly, the orthodontic prescription represents the target alignment and positioning of a patient's teeth following the orthodontic treatment procedures included with the orthodontic treatment plan. The orthodontic prescription may have any suitable form for describing the spatial coordinates of the patient's teeth.

The functional module 122 of the orthodontic treatment platform 102 may facilitate operations of the orthodontic treatment platform 102. In some embodiments, the functional module 122 includes software responsible for the sending and/or receiving of information between the data store 108 and the orthodontic treatment platform 102. In some embodiments, the functional module 122 includes software to facilitate the sending and/or receiving of information between the input module 118 and the prescription module 120. In some embodiments, the functional module 122 includes software that facilitates the sending and/or receiving of information between the user interface module 124 and the first user environment 104 and/or the second user environment 106.

The orthodontic treatment platform 102 may interface with users of the platform through the user interface module 124. As shown in FIG. 1, the orthodontic treatment platform 102 may provide multiple users with access. In some embodiments, users may be orthodontists. For example, the first user 112 may be a first orthodontist working at a first location. The first orthodontist may access the user interface module 124 through the first user device 110. The second user 116 may be a second orthodontist working at a second location. The second orthodontist may access the user interface module 124 through the second user device 114.

In some embodiments, users may be orthodontic technicians. For example, the first user 112 may be a first orthodontic technician and the second user 116 may be a second orthodontic technician. In some embodiments, the first orthodontic technician and the second orthodontic technician may work in the same office. Accordingly, the first user environment 104 and the second user environment 106 may be different treatment rooms in the same office. In some embodiments, the first orthodontic technician and the second orthodontic technician may work in separate offices and the first user environment 104 may be different from the second user environment 106. In some embodiments, users may be persons trained in orthodontic design and trained in use of the orthodontic treatment platform. In some embodiments, any combination of users may use the orthodontic treatment platform 102. For example, the first user 112 may be an orthodontist and the second user 116 may be an orthodontic technician or a specialist in orthodontics design who may aid the orthodontist in designing treatment plans through the orthodontic treatment platform 102.

In some embodiments, the orthodontic treatment platform 102 may be running on the first user device 110 and/or the second user device 114. In some such embodiments, the orthodontic treatment platform 102 communicates with a server over at least one computer-implemented network (not shown) (e.g., the Internet) for retrieving data or execution specific modules of the orthodontic treatment platform 102. However, in some embodiments, the orthodontic treatment platform 102 may be running entirely locally on the first user device 110 and/or the second user device 114.

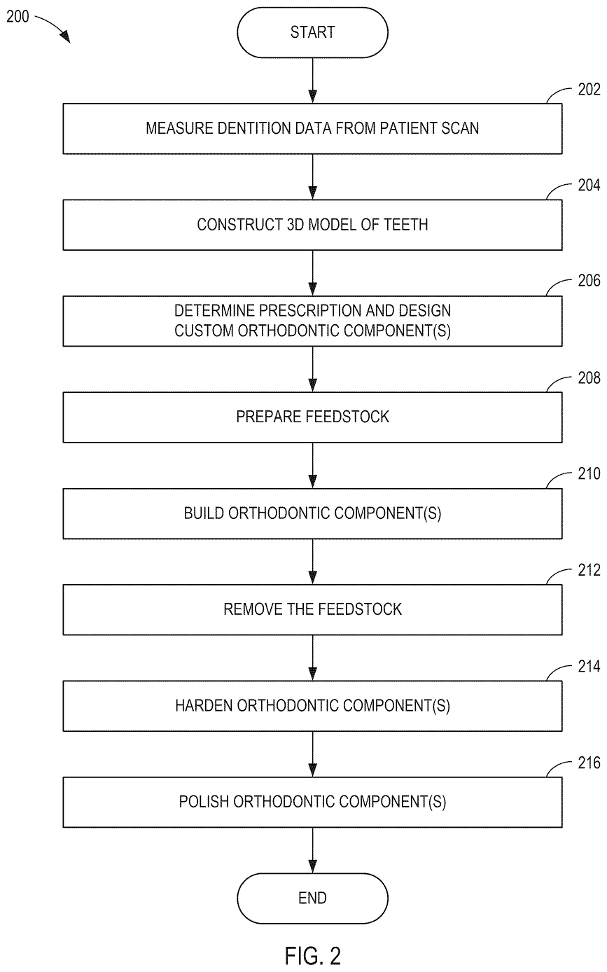

A flowchart of an example custom, additive manufacturing process 200 to manufacture metal and/or ceramic orthodontic components is shown in FIG. 2.

The process 200 begins at block 202, at which dentition data is measured and the parameters of the tooth profile are analyzed. For example, dentition data may be measured using a scanning technique and/or a scanning device. Examples of a scanning technique include computer tomography (CT) scanning, a non-contact three-dimensional (3D) scanner, and an intra-oral scanner directly on the patient's teeth. In some embodiments, dentition data may be measured using 3D readings on a teeth model previously cast. In some embodiments, dentition data may be measured using a coordinate measuring machine, a laser scanner, or structured light digitizers on a 3D printed dental component. The scanning accuracy of such techniques may be less than about 0.02 millimeters (mm). For example, scanning accuracy may be in a range of 0.019 to 0.021 mm.

At block 204, based on the given dentition data, a model (e.g., a 3D computer aided design (CAD) model) of the measured teeth is constructed based on the dentition data and saved in the computer in a file format. Examples of a file format include the .stl format and the additive manufacturing file (AMF) format. Exterior structure of teeth may include irregular curves. Modeling software may be used to re-arrange the teeth in the model to the desired treatment outcomes that may be based on the long axis of a tooth.

At block 206, prescription and design custom orthodontic component(s) are determined. For example, additional information, such as the desired torque, offset, angulation of select brackets and occlusal/incisal coverage for placement guide, may be entered into the planning system. The orthodontic component(s) is/are designed by the software based on the input model of the measured teeth, the model of the desired treatment outcomes, and any input additional information. The output of the design process may be a model, such as a 3D CAD model. Such a model may be designed for a single orthodontic structure, including for example the bracket base surface in contact with teeth surface, as well as the slots for the ideal position according to the orthodontia requirement, bracket material, and tooth profile.

At block 208, a feedstock material is prepared, wherein the feedstock material is made of organic and/or inorganic compounds, for use by the additive manufacturing device. In some embodiments, the feedstock material is a mixture of an organic agent and a ceramic powder.

In some embodiments, the feedstock material is a polymer composite, made from a photopolymerized polymer and metal particulates. In some such embodiments, 90% or more of the metal particulates in the polymer composite are smaller than or equal to 1 micron to 30 microns. Examples of the metal particulates include stainless steel, platinum, gold, silver, tantalum, titanium, steel, and cobalt particulates. In some embodiments, the feedstock material is a ceramic feedstock material.

At block 210, the additive manufacturing process builds the orthodontic component(s) layer-by-layer by generating an (initial) brick of material. In some embodiments, the additive manufacturing process is performed by wiping (or scraping) a small layer of material over a build plate, projecting a pattern onto the layer, wiping another layer over the build plate, projecting another pattern, and so on, until the full brick of material is complete. In some embodiments, the brick of material includes unpolymerized feedstock and the orthodontic component(s) supported within the brick of material. This can allow for printing metal orthodontic components of almost any geometry due to how the brick supports the printed orthodontic component(s) during the printing process. In some embodiments, a height of a printed layer ranges from 1 micron to 30 microns.

In some embodiments, the orthodontic component(s) are made of metal. In some embodiments, the orthodontic component(s) are made of a combination of metal and ceramic.

For example, ceramic brackets and metal brackets can be used in the same case, as there is no interaction between the ceramic brackets and the metal brackets. Moreover, the ceramic brackets are often accompanied by stock metal brackets (e.g., stock metal posterior brackets prior to the inclusion of custom posterior brackets). Due to the materials relatively lower hardness, the use of metal brackets, on some or all teeth, reduces the overall risk of enamel damage associated with ceramic appliances in orthodontics.

At block 212, after the layer-by-layer printing process, the feedstock can be removed to separate the orthodontic component(s) from the feedstock.

In some embodiments, the feedstock is softened and/or melted using an air jet. In some embodiments, the feedstock is removed using an ultrasonic treatment. In some embodiments, the feedstock is recovered after the orthodontic component(s) are removed for reuse in subsequent additive manufacturing processes.

In some embodiments, selective laser melting (SLM) is used as an additive manufacturing process. In this example, the polymer composite is loaded into a manufacturing bed in an SLM apparatus. A laser beam photopolymerizes the polymer composite to form the feedstock. In some embodiments, the feedstock is removed by softening and/or melting the feedstock and removing the orthodontic component(s) within.

At block 214, the orthodontic component(s) is/are hardened for orthodontic use. In some embodiments, the hardening is a consequence of cooling rate of the orthodontic component(s) after printing. In some embodiments, heat treatments are applied to the orthodontic component(s) to heat the orthodontic component beyond their crystalline form. In some embodiments, the orthodontic component(s) are heated in a furnace after printing. In such an embodiment, the furnace heats the orthodontic component(s) to a peak temperature and controls the cooling rate of the orthodontic component(s) within. In some embodiments, the cooling rate of the orthodontic component(s) controls a precipitation of metal particulates in a crystalline structure formed during the printing process.

At block 216, the orthodontic component(s) is/are polished for orthodontic use. A portion of an orthodontic component(s), such as a bracket or tube, with a rough surface may be beneficial since a rough surface enhances adhesion of the bracket to the tooth surface and increases the bond strength between the bracket and the tooth surface. However, an orthodontic component(s) with a (visible) rough surface may be aesthetically unappealing to a patient and/or may be uncomfortable for the patient to wear. Additionally or alternatively, other potential issue with rough surfaces may be corrosion of the bracket while in the mouth (thus, affecting biocompatibility) and/or the formation of plaque on the surface, leading to hygiene issues and/or potentially causing friction that disables the bracket from allowing wire sliding. Polishing allows for control over which portions of the orthodontic component(s) remain rough, and which portions of the orthodontic component(s) become polished. Polishing may be used with customized metal orthodontic appliances to burnish the surface, leading to a polishing that has minimal effect on the dimension of the orthodontic appliances.

In some embodiments, polishing may include sand blasting, centrifugal disk polishing, and/or magnetic pin polishing.

After polishing the orthodontic component(s) at block 216, the process 200 of FIG. 2 conclude.

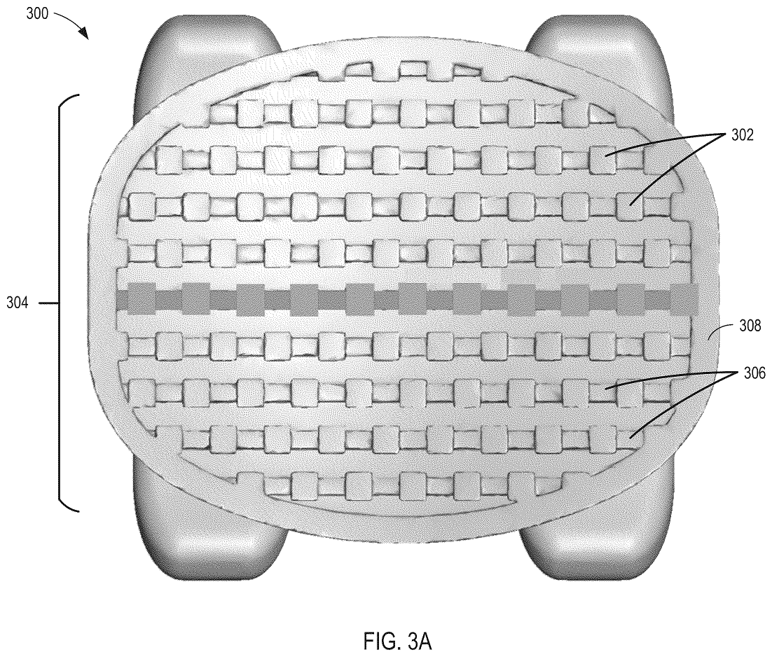

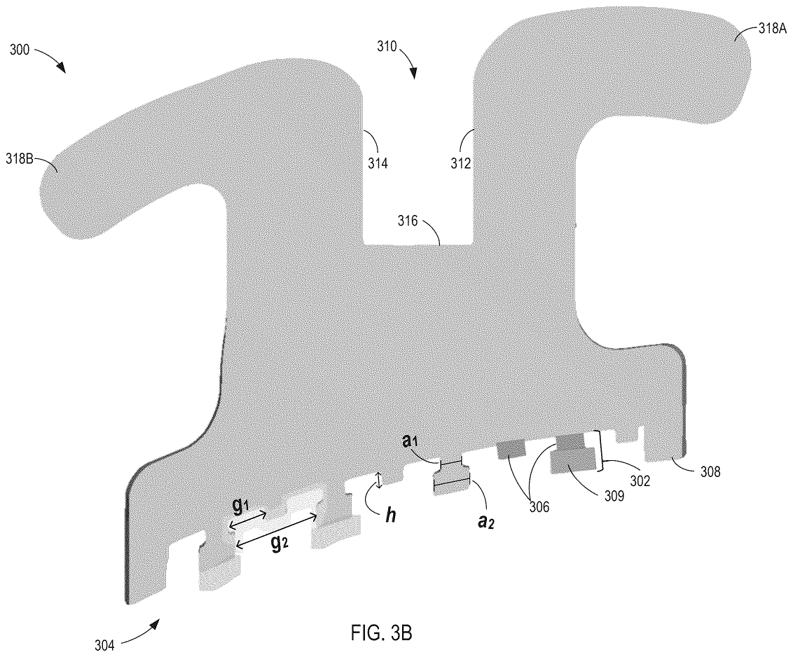

In some embodiments, the customized orthodontic component(s) may include a base with retentive structures configured to anchor the appliance to a tooth when mounted to the tooth using an adhesive. FIG. 3A shows a rear perspective of a customized metal orthodontic bracket 300 with an example implementation of the retentive structures shown as a plurality of retentive structures 302. As shown, the plurality of retentive structures 302 extend outwards from a base surface 304 of the bracket 300. As shown, the bracket base surface 304 includes a plurality of bars 306 and a wall 308. Some of the retentive structures 302 are connected between ones of the plurality of the bars 306. Some of the retentive structures 302 are connected to the wall 308.

FIG. 3B shows a cross-sectional side view of the customized metal orthodontic bracket 300 of FIG. 3A. As shown, the retentive structures 302 and the bars 306 are disposed on the bracket base surface 304. As shown, the retentive structures 302 include a retentive structure pad 309 disposed on a bar 306. The bracket 300 includes a slot 310 with a first side 312, a second side 314, and a slot base 316. The cross section of the bracket 300 includes a first tie-wing 318A and a second tie-wing 318B (collectively “318”).

In some embodiments, the bracket base surface 304 and the bracket base surface 304 may be contoured according to the shape of a tooth surface (not shown). In some embodiments, a bar of the plurality of bars 306 may be contoured to the shape of the bracket base surface 304. Each bar of the plurality of bars 306 may be respectively parallel to each other. In some embodiments, some or all of the plurality of bars 306 may have no retentive structure pads 309.

In some embodiments, the bracket base surface 304 may include a wall 308 that surrounds the plurality of retentive structures 302 and extends from the bracket base surface 304 further than at least some of the retentive structures 302. In such embodiments, the wall 308 encircles a cavity on the bracket base surface 304 wherein the retentive structures 302 are within the cavity. In some embodiments, the wall 308 includes a full perimeter around the bracket base surface 304 of the bracket 300 that is contoured to the shape of the tooth of the patient. In some embodiments, the retentive structure pads 309 also define the wall 308, wherein the wall 308 extends further from the bracket base surface 304 than at least some of the retentive structures 302. In some embodiments, the retentive structure pads 309 of the plurality of retentive structures 302 are separate from the wall 308.

The retentive structure pads 309 may be positioned on a distal surface of the plurality of bars 306 that face away from the main bracket body (and thus, towards the surface of the tooth when mounted to the tooth). In some embodiments, an intaglio surface of each retentive structure 302 may be contoured according to the shape of the tooth surface. In some embodiments, a pattern of retentive structure pads 309 and bars 306 across the bracket base surface 304 may be customized for each bracket 300 and/or orthodontic component.

In some embodiments, a pair of neighboring bars includes retentive structure pads 309 that are staggered from each other, such that the retentive structure pads 309 on a first bar of the pair is offset from neighboring pads of a second bar. The offset can be configured to facilitate flow of adhesive under overhangs of the retentive structure pads 309. In some embodiments, the plurality of retentive structures 302 have a positive draft angle greater than 0 degrees (°).

In some embodiments, each retentive structure is a three-dimensional structure having a shape corresponding to a semi-lunar cone, a full-circle cone, a square, a retentive lattice, a mesh, or a combination thereof.

In some embodiments, each bar of the plurality of bars 306 may have a cross-sectional area of a₁ and each retentive structure pad 309 may have a cross-sectional area of a₂. The cross-sectional area of each bar a₁ may be less than the cross-sectional area of each retentive structure a₂. The cross-sectional shapes may be of the same and/or different geometric shape. For example, the cross-sectional areas a₁ and a₂ may be rectangular as shown in FIG. 3A.

As another example, the cross-sectional areas a₁ and a₂ may be trapezoidal. In such an example, the retentive structure pad 309 has a face surface being a neutral plane and the bars 306 have a base surface being a base plane, wherein the neutral plane is oriented towards a tooth structure or a tooth surface and the base plane is oriented toward a bracket 300 body. In some embodiments, the neutral plane is wider than the base plane. In some embodiments, each neutral plane is parallel to the bracket base surface 304. In some embodiments, each neutral plane is flat. In some embodiments, at least some of the neutral planes are contoured to the shape of the tooth surface to which the bracket is to be bonded. In some embodiments, at least some of the neutral planes are not parallel to the base planes.

In some embodiments, a₁ ranges from approximately 0.025 to 0.25 millimeters (mm). In some embodiments, a₂ ranges from approximately 0.025 to 0.5 mm.

Each bar of the plurality of bars 306 has a height h, measured perpendicular to a₁ and/or a₂. In some embodiments, the bars of the plurality of bars 306 have the same height. In some embodiments, a portion of the bars of the plurality of bars 306 have the same height. In some embodiments, the plurality of bars 306 all have different heights. In some embodiments, some bars of the plurality of bars 306 have different heights such that the top surface of the retentive structure pads 309 are not the same distance from the tooth.

As shown in FIG. 3B, the retentive structures 302 and plurality of bars 306 form an intaglio surface on the bracket base surface 304 of the bracket 300. The intaglio surface of the wall 308 may be contoured according to the shape of the tooth. The plurality of bars 306 and plurality of retentive structures 302 may be arranged separate from the wall 308. The plurality of bars 306 and plurality of retentive structures 302 may be arranged interior to the wall. As shown in FIG. 3A, some of the retentive structures 302 may overlap and/or form part of the wall 308.

In some embodiments, adjacent bars of the plurality of bars 306 are separated by a gap g₁. Adjacent retentive structures of the plurality of retentive structures 302 may be separated by a gap g₂. The adjacent gaps g₁ and g₂ may vary in width. In some embodiments, g₁ ranges from approximately 0.1 to 0.4 mm. In some embodiments, g₂ ranges from approximately 0.2 to 0.6 mm. In some embodiments, the gap g₂ defines a space and/or recess separating the retentive structures 302.

Beneficially, polishing the bracket 300 of FIGS. 3A and 3B may allow for enhanced control over which portions of the bracket 300 remain rough, and which portions of the bracket become polished. In some embodiments, a subset of polishing techniques may be used with customized metal orthodontic appliances as they are insensitive to changing dimensions of the brackets.

The polishing media size and size of the retentive structures 302 may allow only an intaglio surface of each retentive structure to be polished, while the remaining surfaces of the bracket base 300 remain rough. The cross-sectional area a₂ of the retentive structures 302 may minimize and even obscure the polishing from polishing surfaces other than the distal surfaces of the retentive structures 302. That is, the gaps g₂ between adjacent retentive structures may be smaller than the polishing media. The cross-sectional area a₂ of the retentive structures 302 and the gaps g₂ between adjacent retentive structures may be determined based on the size of the polishing media and/or vice versa. In some embodiments, gaps g₁ and g₂ are configured such that the space between the bars remains unpolished after the polishing step.

In some embodiments, a first bar is disposed on the bracket base surface 304 wherein the first bar is not polished. In such an embodiment, the first bar is polished less than a front surface of a first retentive structure of the plurality of retentive structures 302, wherein the front surface is a surface of the retentive structure pad 309 facing outward the bracket base surface 304.

In some embodiments, the printing orientation can be configured to control (with fine accuracy) desired aspects of the orthodontic appliance. In some embodiments, the slot 310 is configured to receive an archwire. In some embodiments, the first side 312 of slot 310 may be substantially parallel to the second side 314 of slot 310. The slot base 316 may be between, and orthogonal to, both the first side 312 and the second side 314. As shown in FIG. 3B, the first side 312 is proximate to the first tie-wing 318A and the second side 314 is proximate to the second tie-wing 318B.

In some embodiments, bracket 300 may be produced by an additive manufacturing process (e.g., metal Digital Light Processing (DLP)), such as that described in conjunction with FIG. 2. This can provide for customization of, for example, bracket geometry, base dimensions, tie-wing parameters, and/or hook shape/type/angle, as discussed further herein. The z-axes of the additive manufacturing machine may be oriented along the gingival-occlusal directions of the bracket 300 such that the custom metal orthodontic bracket is generally printed either upright or upside-down, where the gingival-occlusal axes is the upright/upside-down axes in the mouth. This printing orientation is advantageous because the magnitude of over-polymerization in the z-direction is typically smaller than the over-polymerization in the xy-direction, which can increase the accuracy and control over a desired slot size (e.g., due to control of the layer thickness, as discussed further below).

The bracket 300 may be printed in an orientation where a plurality of layers are parallel to a same direction as that of which the slot 310 is configured to receive the archwire. As the layers are printed in an orientation parallel with the motion of the wire, this printing orientation may reduce the frictional force between the wire and the slot 310. In such an embodiment, a first 3D printed layer may define the first side 312 of the slot 310 and a second 3D printed layer may define the second side 314 of the slot 310. A plurality of 3D printed layers may be printed between the first 3D printed layer and the second 3D printed layer and may define the slot base 316 of the slot 310. The number of layers between the first 3D printed layer and the second 3D printed layer may define the size of the slot 310.

An accurate slot size is important to manufacturing accurate customized metal orthodontic brackets. The height of each layer may be fine-tuned for increased control over the desired slot size. The height of each layer may range from 1 micron to 30 microns.

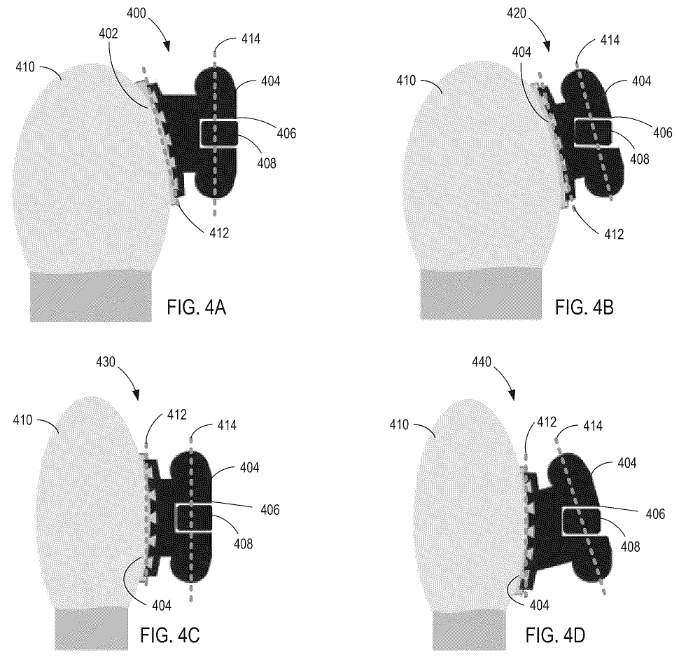

In some embodiments, various aspects of the bracket can be controlled in the design and printing process to provide a custom torque for the bracket. FIGS. 4A-4D show customized metal orthodontic brackets. FIG. 4A shows a first bracket 400 including a bracket base 402, a bracket face 404, a slot 406, and an archwire 408. The bracket base 402 extends along a tooth 410 at a base slope 412. The bracket face 404 has a face slope 414 extending along a central axis of the bracket face 404. A second bracket 420 of FIG. 4B, a third bracket 430 of FIG. 4C, and a fourth bracket 440 of FIG. 4D include the components described above for FIG. 4A, as shown.

As shown, the bracket face 404 is opposite bracket base 402. The bracket face 404 may be contoured according to the shape of a portion of the tooth 410 surface as such that the face slope 414 is parallel to the base slope 412, as shown in FIGS. 4B and 4C. The bracket 400 may be placed on either a buccal or labial tooth surface. Both the bracket face 404 and the bracket base 402 may be contoured according to the buccal or labial tooth surface, accordingly. The bracket 400 may be placed on any location of the buccal or labial tooth surface.

The base slope 412 of the bracket base 402 may be the same as, or similar to, the face slope 414 of the bracket face 404, as shown in FIGS. 4B and 4C. The direction of the motion of the archwire 408 may be angled with respect to the base slope 412 of the bracket base 402, allowing the space behind the bracket face 404 to be minimized where the slot 406 is closer to the surface of the tooth 410 as in the customized torque bracket design of FIGS. 4B and 4C. In this example, a lower profile bracket may improve patient comfort and treatment efficiency. When the slot 406 is closer to the surface of the tooth 410, forces applied to the tooth 410 via the archwire 408 are closer to a center of resistance where fewer side-effects of tooth movement occur. The lower profile of the bracket 400 may increase accuracy and predictability of a final tooth position with respect to an orthodontic treatment plan.

FIGS. 4A and 4D illustrate an embodiment where the base slope 412 of the bracket base 402 and the face slope 414 of the bracket face 404 are not approximately equal. As such, in FIGS. 4A and 4D, the slot 406 is further away from the surface of the tooth 410 compared to FIGS. 4B and 4C. When the bracket 400 has a higher profile and the slot 406 is further away from the tooth 410, this may increase irritation for a patient and unpredictability on the final tooth position with respect to an orthodontic treatment plan.

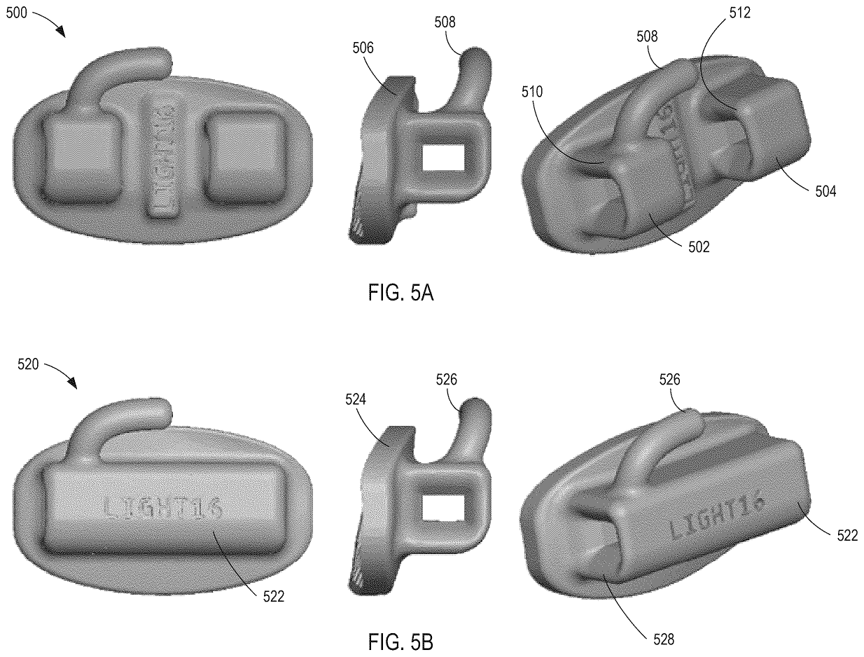

FIG. 5A shows a customized metal orthodontic tube 500 with a first tube 502 and a second tube 504. The customized metal orthodontic tube 500 further includes a tube base 506 and a hook 508. The first tube 502 includes a plurality of first walls 510 and the second tube 504 includes a plurality of second walls 512.

At least a first tube 502 and a second tube 504 may be disposed on a proximal surface of tube base 506. The first tube 502 and the second tube 504 may be configured to receive an archwire. The first tube 502 and the second tube 504 may have chamfered edges. The chamfered edges of each tube may be configured to help guide the archwire through the first tube 502 and the second tube 504. The first tube 502 and the second tube 504 may be located at any position on the tube base 506. The first tube 502 may be dimensionally identical to the second tube 504. The first tube 502 may be dimensionally different from the second tube 504.

The customized metal orthodontic tube 500 of FIG. 5A may be configured to aid in easier cleaning and polishing during the manufacturing process.

The first tube 502 and/or the second tube 504 may include a hook 508. The hook 508 may be angled. The hook 508 may be disposed on any position of the first tube 502 and/or the second tube 504. The hook 508 may be placed on a position of the first tube 502 and/or the second tube 504 to maximize comfort for the patient. The location of the first and second tubes 502, 504 on the tube base 506 can be customized based on the anatomy of the patient.

FIG. 5B shows a customized metal orthodontic tube 520 with one tube 522. The customized metal orthodontic tube 520 includes a base 524 and a hook 526. The one tube 522 includes a plurality of walls 528.

As shown, the one tube 522 is disposed on the base 524. The hook 526 is disposed on the one tube 522. The one tube 522 may be configured to receive an archwire.

The hook 526 may be angled. The hook 526 may be disposed on any position and/or location of the one tube 522. The hook 526 may be placed on a position/location of the one tube 522 to maximize comfort for the patient. The position/location of the one tube 522 on the base 524 may be customized based on the anatomy of the patient.

The choice of the customized metal orthodontic tube 520 may be designed based on the patient anatomy, treatment preferences, and/or the like.

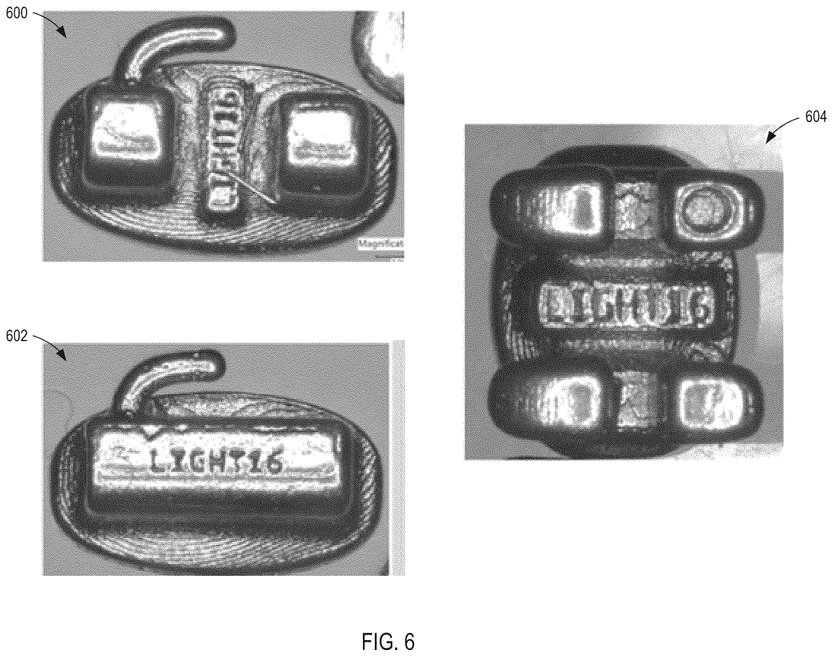

The techniques can include printing and/or otherwise marking text and/or symbols on the orthodontic component. FIG. 6 illustrates a result of direct part marking on a bracket and a tube. A two-tubed orthodontic tube 600, a single tubed orthodontic tube 602, and an orthodontic bracket 604 are shown.

Direct part marking may be advantageous to allow for bulk manufacturing and traceability of brackets and tubes. A direct part marking may be located on any portion of the bracket or tube. A direct part marking may be an alphanumeric, barcode, QR code, datamatrix, and/or symbol(s). The direct part marking may include an identification of the patient, an indication of the treatment plan, an identification of a tooth, and/or a manufacturing label, including manufacturing instance. In the example of FIG. 6, a direct part marking of “LIGHT16” is legible on both a bracket and a tube.

The font design may be optimized to compensate for the pixel size, the layer thickness and alignment, and the printer parameters to account for over-polymerization and/or under-polymerization. The font design may be optimized for legibility and printability. For example, printing an intruded letter “I” with a thickness of 100 microns may result in an intruded letter “I” with a thickness of less than 100 microns due to over-polymerization. In order to compensate for over-polymerization from the additive manufacturing machine, the letter “I” may be thickened by a percentage in the STL file (or .stl file) to mitigate printing behavior and end up with a result that measures 100 microns. In another example, to compensate for over-polymerization of the height of an intruded letter “I” the height may be increased by a percentage less than the letter thickness.

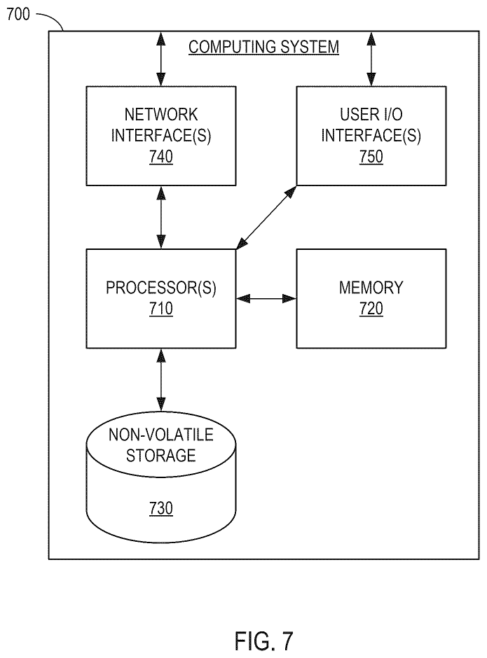

An illustrative example implementation of a computing system 700 that may be used in connection with any of the embodiments of the technology described herein (e.g., such as the method of FIG. 2) is shown in FIG. 7. For example, the computing system 700 can be configured to execute processor-executable instructions to cause at least one hardware processor to execute, perform, and/or cause to occur at least one block of the process 200 of FIG. 2.

The computing system 700 includes one or more processors 710 and one or more articles of manufacture that comprise non-transitory computer-readable storage media (e.g., memory 720 and one or more non-volatile storage device(s) 730). Examples of the one or more processors 710 include central processing units (CPUs), graphics processing units (GPUs), field programmable gate arrays (FPGAs), and microcontrollers.

The processor 710 may be configured to control writing data to and reading data from the memory 720 and the non-volatile storage device 730 in any suitable manner, as the aspects of the technology described herein are not limited to any particular techniques for writing or reading data. To perform any of the functionality described herein, the processor 710 may execute one or more processor-executable instructions stored in one or more non-transitory computer-readable storage media (e.g., the memory 720), which may serve as non-transitory computer-readable storage media storing processor-executable instructions for execution by the processor 710.

Computing system 700 may also include a network input/output (I/O) interface 740 via which the computing system 700 may communicate with other computing system 700 (e.g., over a network), and may also include one or more user I/O interfaces 750, via which the computing system 700 may provide output to and receive input from a user. The user I/O interfaces 750 may include devices such as a keyboard, a mouse, a microphone, a display device (e.g., a monitor or touch screen), speakers, a camera, and/or various other types of I/O devices.

In some embodiments, the processor(s) 710 implement data transmission between the data store 108 and the orthodontic treatment platform 102, as shown in FIG. 1. In some embodiments, the processor(s) 710 implement data transmission between the input module 118 and the prescription module 120 of the orthodontic treatment platform 102. In some embodiments, the processor(s) 710 implement actions of the functional module 122 of orthodontic treatment platform 102.

In some embodiments, the user I/O interface(s) 750 implement the user interface module 124 of the orthodontic treatment platform 102, as shown in FIG. 1. In some embodiments, the user I/O interface(s) 750 facilitates access of the first user 112 to the first user device 110 in the first user environment 104. In some embodiments, the user I/O interface(s) 750 facilitates access of the second user 116 to the second user device 114 in the second user environment 106.

Computing system 700 may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone, tablet, or any other suitable portable or fixed electronic device, as aspects of the technology described herein are not limited in this respect.

Also, a computer may have one or more input and output devices. These devices may be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks, fiber optic networks, or any suitable combination thereof. As shown in FIG. 7, computing system 700 includes network interface(s) 740 to facilitate network connectivity.

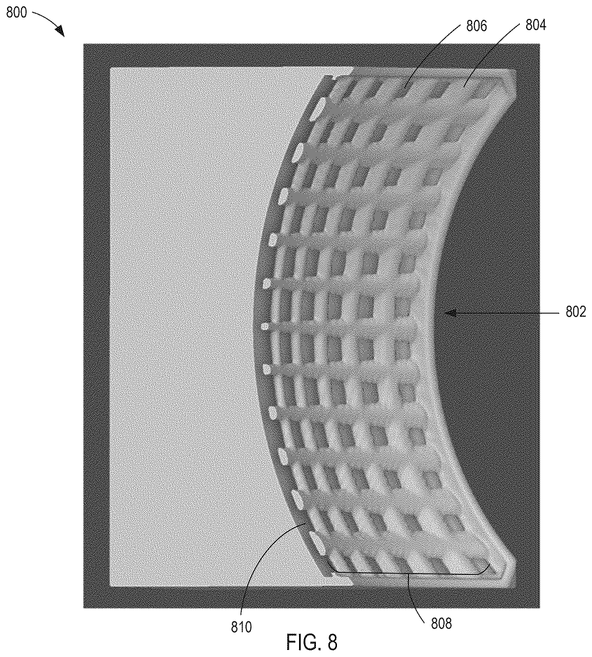

FIG. 8 shows an example orthodontic bracket 800 with a bracket surface 802 including intersecting bars 804. Spaces 806 separate the bars 804 between intersecting regions of the bars 804. The bars 804 and the spaces 806 make up a mesh 808 extending along the bracket surface 802. As shown, gap 810 separates the mesh 808 and the orthodontic bracket 800.

As shown in FIG. 8, the bars 804 form square-shaped spaces 806 between intersections of the bars 804. In some embodiments, the bars 804 may intersect to form the spaces 806 with triangular, trapezoidal, or triangular cross-sections. In some embodiments, a width and height of a space of the spaces 806 ranges from approximately 0.1 to 0.4 mm.

The mesh 808 may be configured to increase structural integrity of the bars 804. In some embodiments, the gap 810 is configured to serve as a well for adhesive material when the orthodontic bracket 800 is bonded to a tooth. In some embodiments, a depth of the gap 810 ranges from 0.025 to 0.25 mm.

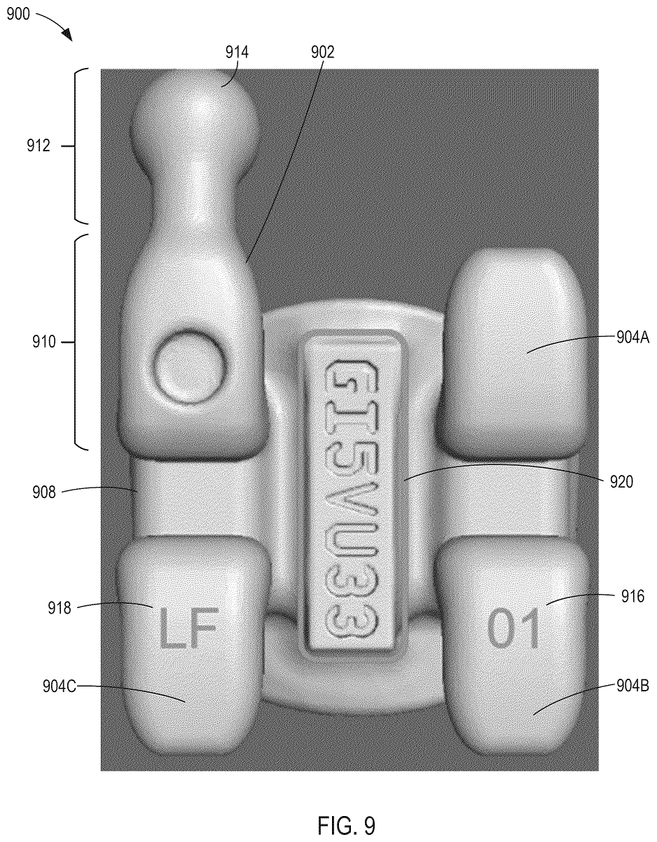

FIGS. 9-14 show alternative perspectives of an example customized, dynamic metal orthodontic bracket 900. Alternatively, the customized, dynamic bracket shown in FIGS. 9-14 may be implemented and/or constructed using ceramic materials. The bracket 900 includes a plurality of tie-wings 904, a hook 902, and a base 908. In the embodiment shown, the bracket 900 includes a first tie-wing 904A, a second tie-wing 904B, a third tie-wing 904C, and the hook 902. The hook 902 includes a first end 910 and a second end 912, wherein the second end 912 is terminated with a ball 914.

FIG. 9 shows the bracket 900 with custom text. Examples of the text include alphanumeric characters. Additionally and/or alternatively, one or more symbols and/or graphics may be used. The custom text includes a first label 916, a second label 918, and a third label 920. In some embodiments, the custom text identifies the specific bracket and patient. In some embodiments, the custom text identifies allows personalization based on doctor and/or patient preference.

As shown in FIG. 9, the first end 910 of the hook 902 is mated to the bracket 900. The second end 912 is opposite the first end 910 and terminates with a ball 914 disposed on the second end 912.

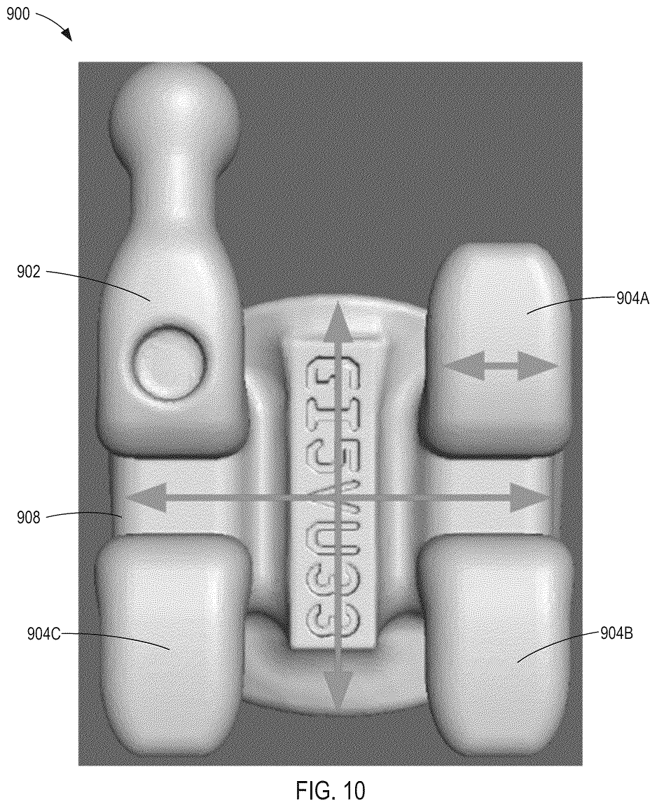

FIG. 10 shows the bracket 900 of FIG. 9 with adjustable height and width of components. As shown, a height and width of the plurality of tie-wings 904 may be adjusted to achieve customization for a particular patient's tooth. As shown, a height and width of the base 908 may be adjusted. In some embodiments, the height and width of the plurality of tie-wings 904 and the base 908 are determined and adjusted with respect to the dimensions of the tooth to which the bracket 900 is to be bonded.

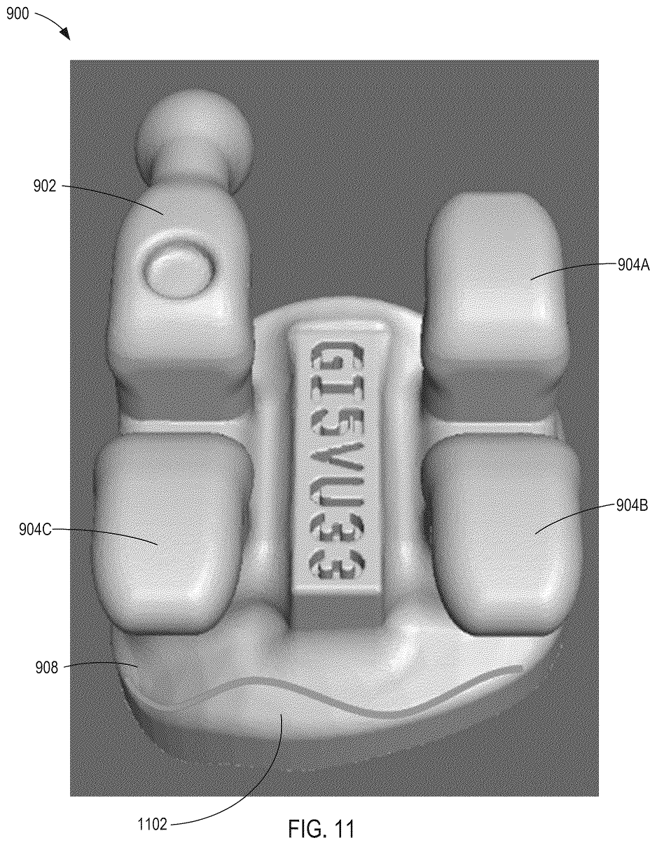

FIG. 11 shows the bracket 900 of FIG. 9 wherein a shape of an edge 1102 of the base 908 is adjustable. In some embodiments the shape of the edge 1102 is determined and adjusted with respect to the dimensions of the tooth to which the bracket 900 is to be bonded. In some embodiments, the edge 1102 of the base 908 is shaped to approximately match a gumline of the tooth to which the bracket is to be bonded.

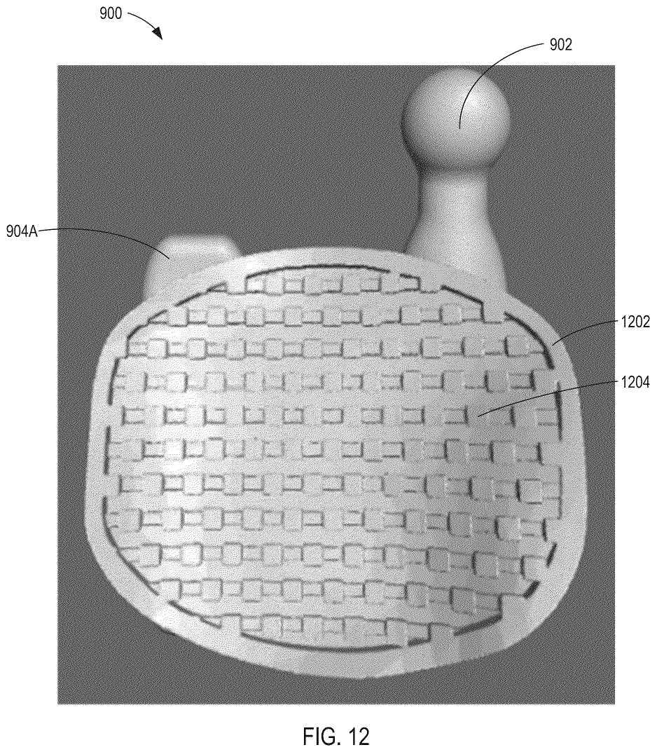

FIG. 12 shows the bracket 900 of FIG. 9 with a base surface 1202 with a plurality of retentive structures 1204 shown. As shown, size and/or spacing of the plurality of retentive structures 1204 can be adjusted. In some embodiments, the size and/or spacing configurable to adjust bonding strength between the bracket and the tooth to which the bracket is to be bonded. In some embodiments, a predetermined bonding strength is determined with respect to bracket thickness and/or debonding risk between the bracket and the tooth to which the bracket is to be bonded.

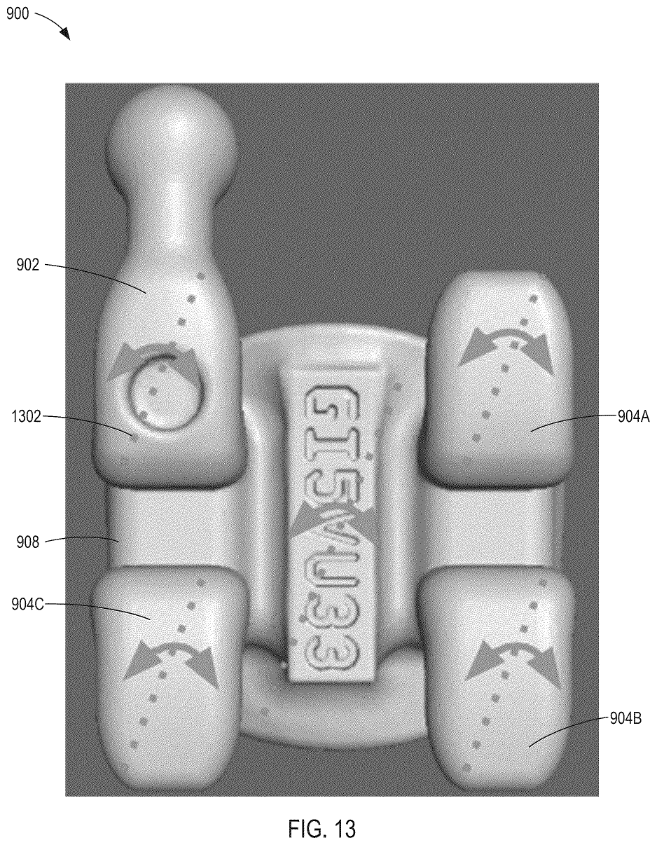

FIG. 13 shows the bracket 900 with central axes 1302 of each of the hook 902, the plurality of tie-wings 904, and the base 908 labeled. As shown, alignment of a respective component of the bracket 900 is adjustable. In some embodiments, the alignment of a respective component of the bracket 900 is determined and adjusted with respect to the dimensions of the tooth to which the bracket 900 is to be bonded. In some embodiments, the alignment of the respective components can be adjusted to provide visual alignment between the bracket 900 and the tooth to which the bracket 900 is to be bonded.

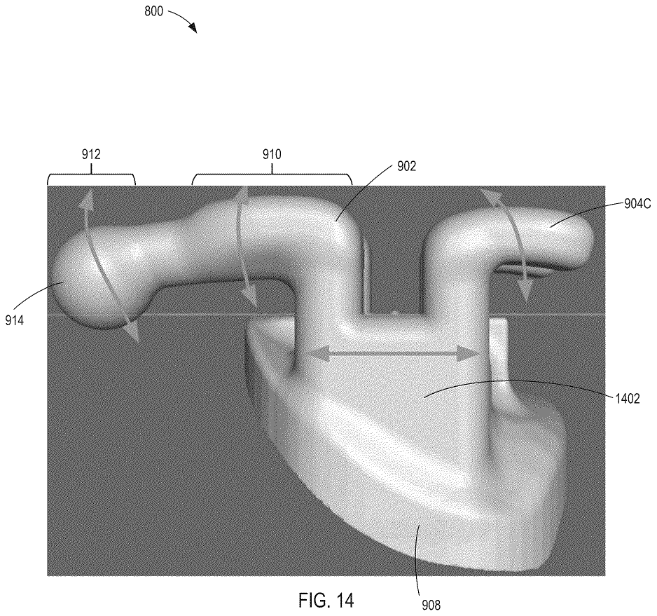

FIG. 14 shows the bracket 900 of FIG. 9 with angular positioning of the hook 902 and the third tie-wing 904C capable of being adjustable for a specified patient. A positioning of a body 1402 extending from the base 908 is also adjustable. In some embodiments, the angular positioning of the first end 910 of the hook 902 and/or the ball 914 of the hook is adjustable with respect to a proximity of the hook to gums of the patient and the tooth to which the bracket 900 is to be bonded. In some embodiments, the angular positioning of the third tie-wing 904C is adjustable with respect to a proximity of the tie-wing to gums of the patient and the tooth to which the bracket 900 is to be bonded. While only the angular positioning of the third tie-wing 904C is shown, the angular positioning of any of the plurality of tie-wings 904 is adjustable. In some embodiments, the position of the body 1402 relative to the base 908 can be shifted respect to a proximity of the plurality of tie-wings 904 to gums of the patient and the tooth to which the bracket 900 is to be bonded.

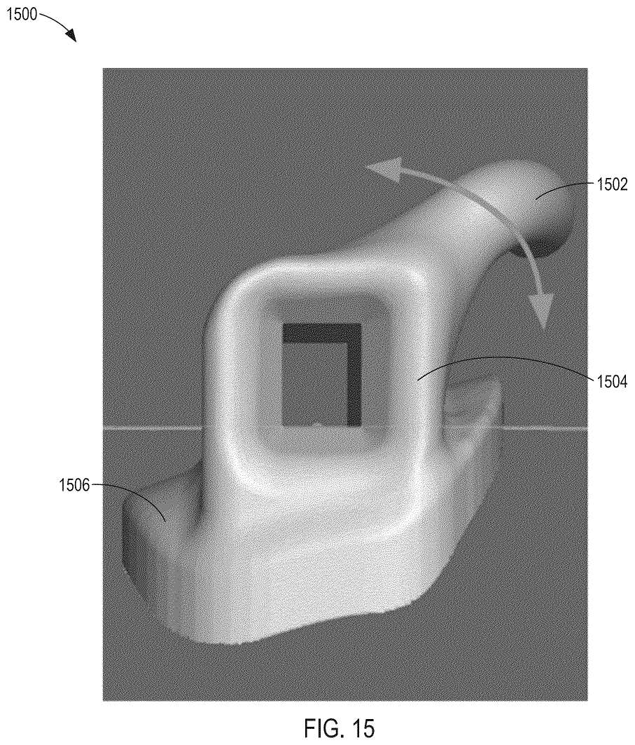

FIG. 15 shows a side-view of a customized, dynamic metal orthodontic tube 1500 with custom angular positioning of a hook 1502. The orthodontic tube 1500 includes a tube 1504 extending from a base 1506. The hook 1502 extends from the tube 1504 of the orthodontic tube 1500. In some embodiments, an angle of the hook 1502 may be shifted respect to a proximity of the hook to gums of a patient and a tooth to which the bracket is to be bonded.

Having thus described several aspects of at least one embodiment of the technology described herein, it is to be appreciated that various alterations, modifications, and improvements will readily occur to those skilled in the art.

Such alterations, modifications, and improvements are intended to be part of this disclosure and are intended to be within the spirit and scope of disclosure. Further, though advantages of the technology described herein are indicated, not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein may be implemented in any of numerous ways. For example, the embodiments may be implemented using hardware, software, or a combination thereof. When implemented in software, the software code may be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media may be transportable, such that the program or programs stored thereon may be loaded onto one or more different computers or other processors to implement various aspects of the technology as described above. As used herein, the term “computer-readable storage medium” encompasses only a non-transitory computer readable medium that may be considered to be a manufacture (i.e., article of manufacture) or a machine.

The terms “program” or “software” are used herein in a generic sense to refer to any type of computer code or set of processor-executable instructions that may be employed to program a computer or other processor to implement various aspects of the technology as described above. Additionally, one or more computer programs that when executed perform methods of the technology described herein need not reside on a single computer or processor, but may be distributed in a modular fashion amongst a number of different computers or processors to implement various aspects of the technology described herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing,” “involving,” and variations thereof, is meant to encompass the items listed thereafter and additional items.

Unless otherwise specified, the terms “approximately,” “substantially,” and “about” may be used to mean within ±10% of a target value in some embodiments. The terms “approximately,” “substantially” and “about” may include the target value.

1. A custom metal orthodontic bracket comprising:
a body;
a plurality of tie-wings; and
a base comprising:
a base surface that is contoured to a shape of a tooth of a patient to which the custom metal orthodontic bracket is to be bonded; and
a plurality of retentive structures, wherein at least one of:
a portion of the base is not polished or only partially polished, or
a portion of at least one of the plurality of retentive structures is not polished or only partially polished.

2. The custom metal orthodontic bracket of claim 1, wherein the bracket is produced by an additive manufacturing device using a three-dimensional (3D) model of a bracket generated using a 3D model of one or more teeth of a patient.

3. The custom metal orthodontic bracket of claim 2, wherein the additive manufacturing device uses a polymer composite comprising metal particulates, wherein 90% of the metal particulates in the polymer composite are smaller than or equal to 1 micron to 30 microns.

4. The custom metal orthodontic bracket of claim 3, wherein the metal particulates comprise at least one of stainless steel, platinum, gold, silver, tantalum, titanium, steel, or cobalt.

5. The custom metal orthodontic bracket of claim 1, wherein the base comprises a plurality of bars, wherein the plurality of bars are disposed on the base surface.

6. The custom metal orthodontic bracket of claim 5, wherein at least one bar of the plurality of bars does not have a retentive structure pad.

7. The custom metal orthodontic bracket of claim 5, wherein the plurality of retentive structures are disposed on a first bar of the plurality of bars, wherein the plurality of retentive structures comprise a larger cross-sectional area than that of the first bar.

8. The custom metal orthodontic bracket of claim 7, wherein a retentive structure of the plurality of retentive structures comprises a first rectangular cross-sectional area, and the first bar comprises a second rectangular cross-sectional area that is less than the first rectangular cross-sectional area.

9. The custom metal orthodontic bracket of claim 5, wherein a pair of neighboring bars comprises a first retentive structure pad and a second retentive structure pad that are staggered from each other, such that the first retentive structure pad of a first bar of the pair is offset from the second retentive structure pad of a second bar, and configured to facilitate flow of adhesive under overhangs of the retentive structure pads.

10. The custom metal orthodontic bracket of claim 5, wherein each bar has a height, and the height is adjustable such that a top surface of retentive structure pads of the retentive structures is not a same distance from the tooth for each retentive structure pad.

11-25. (canceled)

26. The custom metal orthodontic bracket of claim 1, wherein angular positioning of the tie-wings is adjustable with respect to a proximity of the tie-wing to gums of the patient and the tooth to which the bracket is to be bonded.

27. The custom metal orthodontic bracket of claim 1, wherein a positioning of the body relative to the base can be shifted respect to a proximity of the tie-wings to gums of the patient and the tooth to which the bracket is to be bonded.

28. The custom metal orthodontic bracket of claim 1, further comprising a cavity within the base surface, thereby producing a wall at the base surface and ones of the plurality of retentive structures are within the cavity.

29-32. (canceled)

33. The custom metal orthodontic bracket of claim 1, further comprising a slot configured to receive an archwire.

34. The custom metal orthodontic bracket of claim 33, wherein:
a first 3D printed layer defines a first side of the slot;
a second 3D printed layer defines a second side of the slot; and
a set of middle layers between the first and second 3D printed layers define the base of the slot.

35-46. (canceled)

47. The custom metal orthodontic bracket of claim 1, wherein the plurality of retentive structures have a positive draft angle greater than 0 degrees.

48-50. (canceled)

51. A custom metal orthodontic bracket, comprising:
a base comprising a base surface that follows a shape of a portion of tooth of a patient to which the bracket is to be bonded;
a face opposite the base, comprising a face surface that follows the shape of the tooth; and
a slot, comprising a bottom surface and two side surfaces that provide an opening for receiving an archwire in an insertion direction,
wherein the insertion direction is angled with respect to the face surface and the base surface.

52. The custom metal orthodontic bracket of claim 51, wherein the bracket is produced by an additive manufacturing device using a three-dimensional (3D) model of an orthodontic bracket structure, wherein the 3D model of the orthodontic bracket structure is generated using a 3D model of one or more teeth of a patient.

53. The custom metal orthodontic bracket of claim 51, wherein the bracket is placed on either a buccal side or a labial side of the tooth.

54-58. (canceled)

59. A method for additively manufacturing a custom orthodontic bracket, the method comprising:
measuring dentition data of a patient;
constructing, using the dentition data, a three-dimensional (3D) model of at least one tooth of the patient;
designing, using the 3D model of the at least one tooth of the patient, a 3D model of the bracket, the 3D model of the bracket comprising:
a body;
a plurality of tie-wings; and
a base comprising:
a base surface that is contoured to a shape of a tooth of a patient to which the bracket is to be bonded; and
a plurality of retentive structures,
wherein designing the 3D model of the bracket further comprises at least one of:
configuring the base and/or tie-wings to have custom text;
configuring a height and width of the base, the plurality of tie-wings, and/or the base;
configuring a shape of an edge of the base;
configuring a size and/or a spacing of the plurality of retentive structures;
configuring an alignment of the plurality of tie-wings and/or the base with respect to a central axis of each respective component;
configuring angular positioning of the plurality of tie-wings; or
configuring a position of the body relative to the base;
preparing feedstock;
building, using an additive manufacturing device and the feedstock, the bracket;
removing the feedstock;
hardening the bracket; and
polishing the bracket.

60. The method of claim 59, wherein configuring the height and width of the base, the plurality of tie-wings, and/or the base comprises adjusting the height and the width of at least one of the body, the tie-wings, or the base with respect to dimensions of the tooth to which the bracket is to be bonded.

61. The method of claim 59, wherein configuring the shape of the edge of the base comprises shaping the edge of the base to approximately match a gumline of the tooth to which the bracket is to be bonded.

62. The method of claim 59, wherein configuring the size and/or the spacing of the plurality of retentive structures comprises adjusting the size and the spacing of the plurality of retentive structures to adjust bonding strength between the bracket and the tooth to which the bracket is to be bonded.

63. The method of claim 62, wherein adjusting the bonding strength comprises determining a predetermined bonding strength with respect to bracket thickness and debonding risk and configuring the size and/or spacing of the plurality of retentive structures to approximately achieve the predetermined bonding strength between the bracket and the tooth to which the bracket is to be bonded.

64. The method of claim 59, wherein the 3D model of the bracket further comprises at least one hook in place of one of the plurality of tie-wings.

65. The method of claim 64, wherein designing the 3D model of the bracket further comprises adjusting the alignment of the hook with respect to the central axis of the hook.

66. The method of claim 64, wherein the hook comprises a first end mated to the bracket and a second end opposite the first end, and a ball is disposed on the second end.

67. The method of claim 66, wherein designing the 3D model of the bracket further comprises adjusting the angular positioning of the first end and/or the ball of the hook with respect to a proximity of the hook to gums of the patient and the tooth to which the bracket is to be bonded.

68. The method of claim 59, wherein configuring the positioning of the body relative to the base comprises shifting the position of the body relative to the base with respect to a proximity of the tie-wings to gums of the patient and/or the tooth to which the bracket is to be bonded.

69. The method of claim 59, wherein at least one of:
a portion of the base is not polished or only partially polished, or a portion of at least one of the plurality of retentive structures is not polished or only partially polished.

70-71. (canceled)
